(19) United States
(12) Patent Application Publication
(10) Pub. No.: US 2007/0234512 A1
(43) Pub. Date: Oct. 11, 2007

(54) Flat Track

(76) Inventor: Gregory J. Cervantes, Sherman Oaks, CA (US)

Correspondence Address: ADVANTIA LAW GROUP, 9035 SOUTH 1300 EAST, SUITE 200, SANDY, UT, 84094, US

(21) Appl. No.: 11/278,106

(22) Filed: Mar. 30, 2006

(51) Int. Cl. E06B 3/46

(52) U.S. Cl. 16/96 R

(57) ABSTRACT

A novel sliding shower door track for guiding and retaining one or more sliding shower doors at least includes: a column member adapted to be carried by a shower surface; and column ends having at least two sliding door wheel guide and retention grooves, the grooves having T-shaped guide and retention members; the column member further having longitudinally spanning grooves and T-shaped guide and retention members matching those of the end column ends, and the column member side having the grooves and T-shaped guide and retention members protruding therefrom being substantially flat.

### BACKGROUND OF THE INVENTION

1. Field of the Invention

The present invention generally bathroom shower doors, and particularly relates to improvements in the mounting of bathroom shower doors.

2. Description of the Related Art

Sliding shower doors permit easy ingress to and egress from bathroom showers, while protecting the rest of the bathroom from water spillage. However, the tracks used to guide and align the sliding doors are often very uncomfortable when pressed against a body. For example, prior art sliding shower door tracks tend to have relatively sharp edges that make them uncomfortable upon which to sit, and make passage over them painful to pressing body parts.

It is also more awkward for adults to bathe the very young in such an environment.

It is therefore an object of the present invention to eliminate the pain and discomfort sometimes associated with prior art sliding shower door tracks.

### SUMMARY OF THE INVENTION

The present invention has been developed in response to the present state of the art, and in particular, in response to the problems and needs in the art that have not yet been fully solved. Accordingly, the present invention has been developed to provide a novel sliding shower door track for guiding and retaining one or more sliding shower doors that at least includes: a column member adapted to be carried by a shower surface; and column ends having at least two sliding door wheel guide and retention grooves, the grooves having T-shaped guide and retention members; the column member further having longitudinally spanning grooves and T-shaped guide and retention members matching those of the end column ends, and the column member side having the grooves and T-shaped guide and retention members protruding therefrom being substantially flat.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an isometric view of the present-inventive sliding door track as seen from the inside of a shower stall or converted bathtub; and

FIG. 2 is an end view of the present-inventive sliding door track.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment.

The present-inventive sliding door track eliminates the sharp edges of the prior art, with a substantially flat surface to provide more comfort for contacting body parts (e.g., thighs or knees pressed against the track while sitting or kneeling, respectively).

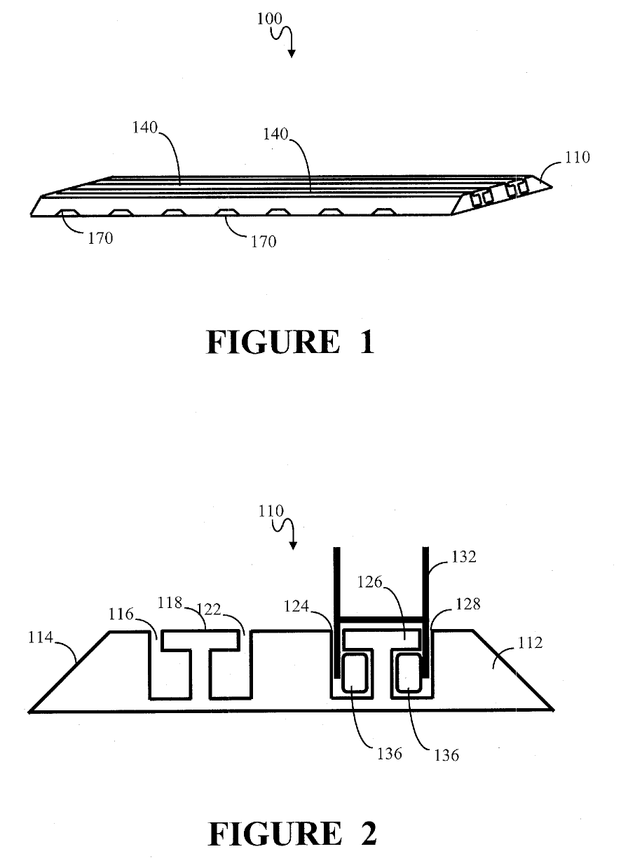

As shown in FIG. 1, the track 100 is substantially in the shape of a column having end members 112 with the cross-sectional shape as shown in FIG. 2. Four span-wise grooves 116 and 122, and 124 and 128 have span-wise T-shaped members 118 and 126, respectively, formed therein. The grooves and T-shaped members cooperate to guide and secure sliding doors such as the one numbered 132. AS shown, door frame wheels 136 engage with the sides of the grooves and T-shaped members to properly register and guide the engaged door.

The track 100 also has several drainage ports or voids 170 (located on the side toward the shower or bathtub) which extend through all grooves and provide drainage of water from the track into the shower or tub.

In practice, the length of the track 100 is chosen to allow a clearance between the track and retaining walls so that sliding door frame wheels can be inserted into the track. Alternatively, wheel insertion voids can be located at other points along the track.

In the preferred embodiment, the track 100 is adapted to be located on a bathtub ledge, or at the floor of a shower stall, as with prior art tracks, although other mounting configurations are possible.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

It is expected that there could be numerous variations of the design of this invention.

Finally, it is envisioned that the components of the device may be constructed of a variety of materials.

Thus, while the present invention has been filly described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A sliding shower door track for guiding and retaining one or more sliding shower doors, said track comprising:
a column member adapted to be carried by a shower surface; and
column ends having at least two sliding door wheel guide and retention grooves, said grooves having T-shaped guide and retention members;
said column member further having longitudinally spanning grooves and T-shaped guide and retention members matching those of said end column ends, and the column member side having said grooves and T-shaped guide and retention members protruding therefrom being substantially flat.

2. The track of claim 1, wherein the cross-sectional shape of said column ends is substantially trapezoidal.

3. The track of claim 1, wherein said column member further has a plurality of water drainage ports adapted to allow the drainage of water from said track.

4. The track of claim 3, wherein said ports are located on one side of said column member.

5. A sliding shower door track for guiding and retaining one or more sliding shower doors, said track consisting essentially of;
a column member adapted to be carried by a shower surface; and
column ends having at least two sliding door wheel guide and retention grooves, said grooves having T-shaped guide and retention members;
said column member further having longitudinally spanning grooves and T-shaped guide and retention members matching those of said end column ends, and the column member side having said grooves and T-shaped guide and retention members protruding therefrom being substantially flat.

6. The track of claim 5, wherein the cross-sectional shape of said column ends is substantially trapezoidal.

7. The track of claim 5, wherein said column member further has a plurality of water drainage ports adapted to allow the drainage of water from said track.

8. The track of claim 7, wherein said ports are located on one side of said column member.

9. A sliding shower door track for guiding and retaining one or more sliding shower doors, said track consisting of:
a column member adapted to be carried by a shower surface, and
column ends having at least two sliding door wheel guide and retention grooves, said grooves having T-shaped guide and retention members;
said column member further having longitudinally spanning grooves and T-shaped guide and retention members matching those of said end column ends, and the column member side having said grooves and T-shaped guide and retention members protruding therefrom being substantially flat.

10. The track of claim 9, wherein the cross-sectional shape of said column ends is substantially trapezoidal.

11. The track of claim 9, wherein said column member further has a plurality of water drainage ports adapted to allow the drainage of water from said track.

12. The track of claim 11, wherein said ports are located on one side of said column member.
